(19) United States
(12) Patent Application Publication
(10) Pub. No.: US 2020/0089361 A1
(43) Pub. Date: Mar. 19, 2020

(54) TOUCH SCREEN CONTROL DEVICE USED FOR LIFT TABLE

(71) Applicant: Dong Guan Song Wei Electric Technology Co., Ltd., Dongguan (CN)

(72) Inventor: Weilin Lu, Dongguan (CN)

(21) Appl. No.: 16/136,202

(22) Filed: Sep. 19, 2018

(51) Int. Cl. G06F 3/041; A47B 9/00; A47B 13/12

(52) U.S. Cl. CPC G06F 3/0416; G06F 3/0412; A47B 2200/004; A47B 13/12; A47B 9/00

(57) ABSTRACT

A touch screen control device used for a lift table includes a rear cover, a printed circuit board, a display device, a touch screen, and a transparent casing. The surface of the display device has a slide symbol area, an up symbol area, and a down symbol area. The user can control the height of the lift table by clicking or sliding the corresponding position on the transparent casing, so that the user can adjust the table top to the desired height at a time. The operation is very convenient.

### BACKGROUND OF THE INVENTION

### 1. Field of the Invention

The present invention relates to a control device, and more particularly to a touch screen control device used for a lift table.

### 2. Description of the Prior Art

A control device is widely applied to various products, which provides convenience for people to use the products. The lift table is a common tool in daily life. Through the control device of the lift table, the user can adjust the table top to a desired height. However, the control device of the conventional lift table cannot adjust the height of the table top to the desired height at a time by touching and cannot meet the user's requirements for convenience, which greatly affects the experience of the user.

Accordingly, the inventor of the present invention has devoted himself based on his many years of practical experiences to solve these problems.

### SUMMARY OF THE INVENTION

In view of the drawbacks of the prior art, the primary object of the present invention is to provide a touch screen control device used for a lift table, which can effectively solve the problem that the control device of the conventional lift table cannot adjust the table top to the desired height at a time by touching.

In order to achieve the above object, the present invention adopts the following technical solutions.

A touch screen control device used for a lift table comprises a rear cover, a printed circuit board, a display device, a touch screen, and a transparent casing. The rear cover has an accommodating chamber with a front opening. The printed circuit board is disposed in the accommodating chamber. The display device is disposed in the accommodating chamber. The display device is electrically connected to the printed circuit board and located in front of the printed circuit board. A surface of the display device has a slide symbol area, an up symbol area, and a down symbol area. The touch screen is disposed in front of the display device and covers the surface of the display device. The touch screen is located in the accommodating chamber. The touch screen is electrically connected to the printed circuit board. The transparent casing covers the front opening of the accommodating chamber. The touch screen is attached to an inner side surface of the transparent casing.

Preferably, the slide symbol area extends vertically or transversely. The up symbol area and the down symbol area are located at two ends of the slide symbol area, respectively.

Preferably, the accommodating chamber is provided with a positioning post and a fixing post. The fixing post has a fixing hole penetrating through two ends thereof. The printed circuit board is provided with a positioning hole and a through hole. The positioning post is inserted into the positioning hole. The through hole is aligned with the fixing hole of the fixing post. A screw is inserted through the fixing hole and the through hole and fixedly connected to the transparent casing.

Preferably, the surface of the display device further has a plurality of fixed value setting areas and a real-time numeric display area. The plurality of fixed value setting areas are arranged in a line and spaced apart from each other in the vicinity of the real-time numeric display area or disposed beside, above or below the slide symbol area. The real-time numeric display area is located above the plurality of fixed value setting areas.

Preferably, the surface of the display device further has a lock symbol area and a reset symbol area.

Preferably, the display device is an LCD screen or a nixie tube. The slide symbol area is disposed on the LCD screen or the nixie tube.

Preferably, the transparent casing is made of a plastic or glass material.

Preferably, the slide symbol area has a strip, circle or semicircle shape.

Preferably, the touch screen is closely attached to the transparent casing.

Compared with the prior art, the present invention has obvious advantages and beneficial effects. Specifically, it can be known from the above technical solutions:

The display device and the touch screen are electrically connected to the printed circuit board circuit, respectively. The surface of the display device is provided with the slide symbol area, the up symbol area, and the down symbol area. The touch screen is disposed in front of the display device and covers the surface of the display device. The user can control the height of the lift table by clicking or sliding the corresponding position on the transparent casing, so that the user can adjust the table top to the desired height at a time. The operation is very convenient.

Embodiments of the present invention will now be described, by way of example only, with reference to the accompanying drawings.

### BRIEF DESCRIPTION OF THE DRAWINGS

FIG. 1 is a perspective view according to a first embodiment of the present invention;

FIG. 2 is an exploded view according to the first embodiment of the present invention;

FIG. 3 is a front view according to the first embodiment of the present invention; and

FIG. 4 is a front view of the display device according to a second embodiment of the present invention.

### DETAILED DESCRIPTION OF THE PREFERRED EMBODIMENTS

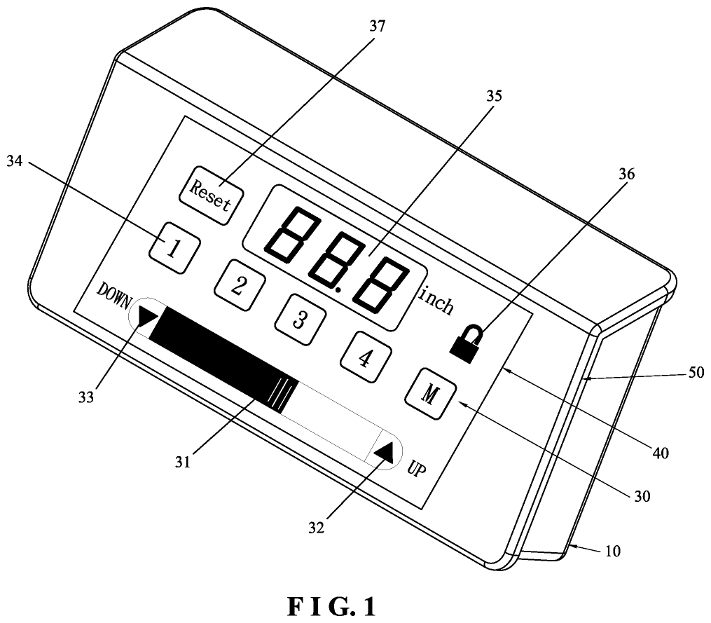

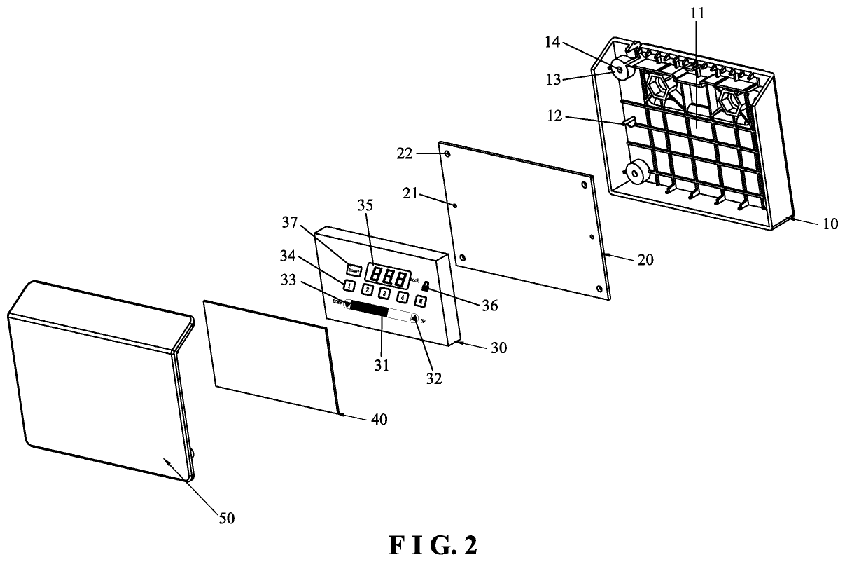

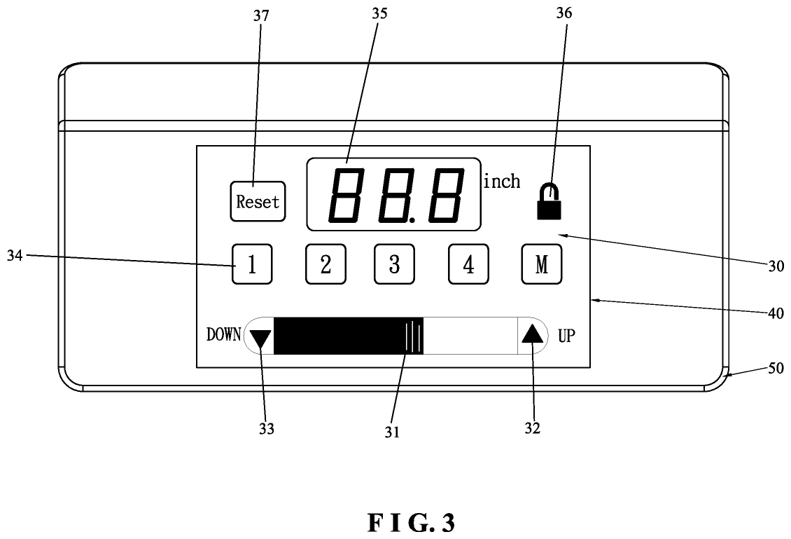

Please refer to FIG. 1 through FIG. 3, which shows a specific structure of a first embodiment of the present invention, comprising a rear cover 10, a printed circuit board 20, a display device 30, a touch screen 40, and a transparent casing 50.

The rear cover 10 has an accommodating chamber 11 with a front opening. The accommodating chamber 11 is provided with a positioning post 12 and a fixing post 13. The fixing post 13 has a fixing hole 14 penetrating through two ends thereof.

The printed circuit board 20 is disposed in the accommodating chamber 11. The printed circuit board 20 is connected to a lifting device of a lift table. The printed circuit board 20 is provided with a positioning hole 21 and a through hole 22. The positioning post 12 is inserted into the positioning hole 21. The through hole 22 is aligned with the fixing hole 14 of the fixing post 13. A screw (not shown) is inserted through the fixing hole 14 and the through hole 22 and fixedly connected to the transparent casing 50, so that the printed circuit board 20 can be fixed in the accommodating chamber 11.

The display device 30 is disposed in the accommodating chamber 11. The display device 30 is electrically connected to the printed circuit board 20 and located in front of the printed circuit board 20. The display device 30 is an LCD screen or a nixie tube. The surface of the display device 30 has a slide symbol area 31, an up symbol area 32, and a down symbol area 33. The slide symbol area 31 may have a strip, circle or semicircle shape, but the shape of the slide symbol area 31 is not limited thereto. In this embodiment, the slide symbol area 31 extends transversely. The up symbol area 32 and the down symbol area 33 are located at two ends of the slide symbol area 31, respectively. The surface of the display device 30 further has a plurality of fixed value setting areas 34 and a real-time numeric display area 35. The plurality of fixed value setting areas 34 are arranged in a line and spaced apart from each other in the vicinity of the real-time numeric display area 35. The plurality of fixed value setting areas 34 may be disposed beside, above or below the slide symbol area 31. In this embodiment, the plurality of fixed value setting areas 34 are arranged in a line and spaced apart from each other and disposed above the slide symbol area 31. The real-time numeric display area 35 is located above the plurality of fixed value setting areas 34. In addition, the surface of the display device 30 further has a lock symbol area 36 and a reset symbol area 37.

The touch screen 40 is disposed in front of the display device 30 and covers the surface of the display device 30. The touch screen 40 is located in the accommodating chamber 11, and the touch screen 40 is electrically connected to the printed circuit board 20.

The transparent casing 50 covers the front opening of the accommodating chamber 11. The touch screen 40 is attached to an inner side surface of the transparent casing 50. The touch screen 40 is closely attached to the transparent casing 50. The transparent casing 50 is made of a plastic or glass material. The user can see the surface of the display device 30 through the transparent casing 50 and the touch screen 40.

The use of this embodiment is described in detail as follows:

When in use, the product of the present invention is connected to the lifting device of the lift table. When the product is started, the display device 30 is illuminated, and the user can see the symbols displayed on the display device 30 through the transparent casing 50 and the touch screen 40. Then, the user can control the lifting device by clicking the symbols displayed on the respective areas or sliding the corresponding position on the transparent casing 50 with his/her finger. For example, when the user slides the corresponding position on the transparent casing 50 against the slide symbol area 31, it can quickly slide to the corresponding position, such that the printed circuit board 20 controls the lifting device to lift the table top to the corresponding height. The operation is very convenient. When the corresponding position on the transparent casing 50 is clicked against the up symbol area 32, the printed circuit board 20 can control the lifting device to raise the table top to the desired height at a time. The operation is very convenient. When the corresponding position on the transparent casing 50 is clicked against the down symbol area 32, the printed circuit board 20 can control the lifting device to lower the table top to the desired height at a time. The operation is very convenient.

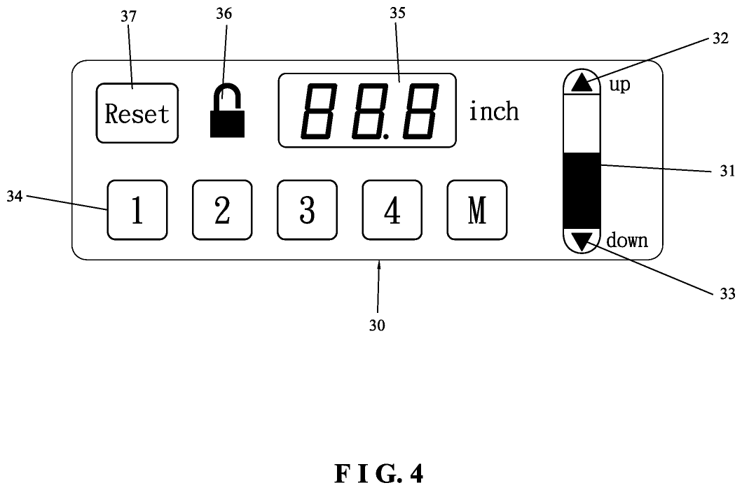

FIG. 4 is a front view of the display device 30 according to a second embodiment of the present invention. The specific structure of the second embodiment is substantially similar to the specific structure of the first embodiment with the exceptions described hereinafter. The slide symbol area 31 of the display device 30 extends vertically. The up symbol area 32 and the down symbol area 33 are located at two ends of the slide symbol area 31, respectively.

The use of the second embodiment is the same as that of the first embodiment described above, so the use of the second embodiment will not be described in detail herein.

The feature of the present invention is described below.

The display device and the touch screen are electrically connected to the printed circuit board circuit, respectively. The surface of the display device is provided with the slide symbol area, the up symbol area, and the down symbol area. The touch screen is disposed in front of the display device and covers the surface of the display device. The user can control the height of the lift table by clicking or sliding the corresponding position on the transparent casing, so that the user can adjust the table top to the desired height at a time. The operation is very convenient.

Although particular embodiments of the present invention have been described in detail for purposes of illustration, various modifications and enhancements may be made without departing from the spirit and scope of the present invention. Accordingly, the present invention is not to be limited except as by the appended claims

1. A touch screen control device used for a lift table, comprising a rear cover, a printed circuit board, a display device, a touch screen and a transparent casing; the rear cover having an accommodating chamber with a front opening; the printed circuit board being disposed in the accommodating chamber; the display device being disposed in the accommodating chamber, the display device being electrically connected to the printed circuit board and located in front of the printed circuit board, a surface of the display device having a slide symbol area, an up symbol area and a down symbol area; the touch screen being disposed in front of the display device and covering the surface of the display device, the touch screen being located in the accommodating chamber, the touch screen being electrically connected to the printed circuit board; the transparent casing covering the front opening of the accommodating chamber, the touch screen being attached to an inner side surface of the transparent casing,
wherein the touch screen covers the surface of the display device and such that the slide symbol area, the up symbol area, and the down symbol area are covered by the touch screen, such that the slide symbol area, the up symbol area, and the down symbol area are observable through the touch screen.

2. The touch screen control device as claimed in claim 1, wherein the slide symbol area extends vertically or transversely, the up symbol area and the down symbol area are located at two ends of the slide symbol area, respectively.

3. The touch screen control device as claimed in claim 1, wherein the accommodating chamber is provided with a positioning post and a fixing post, the fixing post has a fixing hole penetrating through two ends thereof, the printed circuit board is provided with a positioning hole and a through hole, the positioning post is inserted into the positioning hole, the through hole is aligned with the fixing hole of the fixing post, and a screw is inserted through the fixing hole and the through hole and fixedly connected to the transparent casing.

4. The touch screen control device as claimed in claim 1, wherein the surface of the display device further has a plurality of fixed value setting areas and a real-time numeric display area, the plurality of fixed value setting areas are arranged in a line and spaced apart from each other in the vicinity of the real-time numeric display area or disposed beside, above or below the slide symbol area, and the real-time numeric display area is located above the plurality of fixed value setting areas.

5. The touch screen control device as claimed in claim 1, wherein the surface of the display device further has a lock symbol area and a reset symbol area.

6. The touch screen control device as claimed in claim 1, wherein the display device is an LCD screen or a nixie tube, and the slide symbol area is disposed on the LCD screen or the nixie tube.

7. The touch screen control device as claimed in claim 1, wherein the transparent casing is made of a plastic or glass material.

8. The touch screen control device as claimed in claim 1, wherein the slide symbol area has a strip, circle or semicircle shape.

9. The touch screen control device as claimed in claim 1, wherein the touch screen is closely attached to the transparent casing.
